(19) United States
(12) Patent Application Publication
(10) Pub. No.: US 2024/0295859 A1
(43) Pub. Date: Sep. 5, 2024

(54) CONTROL DEVICE

(71) Applicant: FANUC CORPORATION, Yamanashi (JP)

(72) Inventor: Yumeki YUI, Yamanashi (JP)

(73) Assignee: FANUC CORPORATION, Yamanashi (JP)

(21) Appl. No.: 18/261,771

(22) PCT Filed: Mar. 11, 2022
(86) PCT No.: PCT/JP2022/010921

§ 371 Date: Jul. 17, 2023

(30) Foreign Application Priority Data
Mar. 17, 2021 (JP) 2021-043743

(51) Int. Cl. G05B 13/02

(52) U.S. Cl. CPC G05B 13/0265

(57) ABSTRACT

This control device is equipped with: a primary data retention unit for storing, for an interval equivalent to one control period, data to be retained in the control device; a collection settings retention unit which refers to the primary data retention unit and stores a settings channel; a data retention unit which has collection channels for storing the data collected from the control device, each of the collection channels having a queue structure for reading the data in the order in which the data was added; and a data collection calculation unit for reading the settings channel from the collection settings retention unit, reading the data corresponding to the data ID in the settings channel from the primary data retention unit, and executing data collection processing for writing the data read from the primary data retention unit to the desired channel in the data retention unit.

### TECHNICAL FIELD

The present invention relates to a control device.

### BACKGROUND ART

Recently, due to improvement in a computer calculation capacity, feature extraction by machine learning typified by deep learning has been facilitated. There has been a growing demand for analyzing, e.g., a sensor value or a control value obtained from a production facility in a factory to efficiently control and operate the production facility from an obtained analysis result by using such feature extraction by machine learning.

In feature extraction by machine learning, the accuracy of input data for analysis is important to obtain a more-accurate analysis result, and it is also important that there is a correlation between data and data.

It is the most efficient technique that in the production facility, data is collected from a control device that directly controls an industrial machine such as a machine tool (see, e.g., Patent Document 1). Moreover, it is obvious that in the control device controlled according to a program, a sensor value and a control value have a cause-and-effect relationship in chronological order. Thus, it is important to collect, with high accuracy, data on a sensor value, a control value, a state value, etc. in the control device in chronological order.
Patent Document 1: Japanese Unexamined Patent Application, Publication No. 2019-109697

### DISCLOSURE OF THE INVENTION

### Problems to be Solved by the Invention

In some cases, on a production line, a plurality of users (e.g., machine builder, department in charge of a production site, and department in charge of a line design over the entire factory) wants to perform data collection as described above.

For example, any user wants to collect information (data) on a machine tool, such as an X-axis coordinate or an execution program at a certain point of time. Conventionally, in a case where different data requesters request the same data, the control device collects the same data multiple times for each requester. This becomes a burden on data collection processing in the control device.

For these reasons, there has been a demand for reducing the burden on the data collection processing in a case where a plurality of users has requested the same data.

### Means for Solving the Problems

A control device according to one aspect of the present disclosure is a control device provided in an industrial machine to collect data, the control device including a primary data holding unit that stores data, which corresponds to a single control period, held in the control device, a collection setting holding unit that stores a collection setting including a reference to the primary data holding unit, a data ID specifying data collected from the control device, and a request user list which is the list of users having requested the data ID, a data holding unit that has a collection channel for storing data collected from the control device and has, in the collection channel, a queue structure for reading data in the order of addition of data, and a data collection calculation unit that executes data collection processing including reading the collection setting from the collection setting holding unit, reading data corresponding to the data ID of the collection setting from the primary data holding unit, and writing the data read from the primary data holding unit in an arbitrary channel in the data holding unit.

### Effects of the Invention

According to the present invention, the burden on the data collection processing can be reduced, a high-load control program can be executed, and more data can be collected.

### BRIEF DESCRIPTION OF THE DRAWINGS

FIG. 1 is a diagram showing the outline of a control device and an industrial machine according to the present embodiment;

FIG. 2 is a diagram showing one example of a setting channel which is a collection setting stored in a collection setting holding unit;

FIG. 3 is a diagram showing one example of a channel list stored in a data holding unit;

FIG. 4 is a timing chart regarding processing by each component of the control device according to the present embodiment;

FIG. 5 is a flowchart showing the flow of processing in control period interrupt; and

FIG. 6 is a flowchart showing the flow of collection task processing.

### PREFERRED MODE FOR CARRYING OUT THE INVENTION

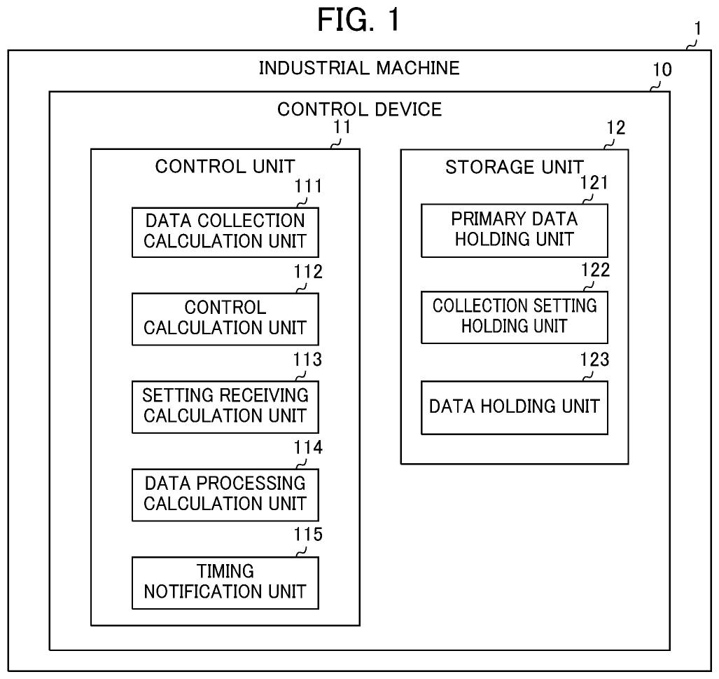

Hereinafter, one example of an embodiment of the present invention will be described. FIG. 1 is a diagram showing the outline of a control device 10 and an industrial machine 1 according to the present embodiment. The control device 10 is provided in the industrial machine 1 to collect arbitrary data in the industrial machine 1. Specifically, the control device 10 collects data output from a sensor connected to the control device 10 and arbitrary control information in the control device 10.

The control device 10 may be, for example, a programmable logic controller (PLC), a numerical control device, or a robot controller. The control device 10 is connected, for example, to a sensor, a servomotor, or a spindle motor in the industrial machine 1.

The industrial machine 1 includes, for example, industrial machines controllable by numerical control, such as a machine tool, a press machine, a press fitting instrument, a die-cast machine, an injection molding machine, a cutting machine, a robot, a carrier machine, a measuring instrument, a testing device, a printing machine, a food machine, a packing machine, a welding machine, a washing machine, a painting machine, an assembling device, a mounting machine, a woodworking machine, and a sealing device.

The control device 10 includes a control unit 11 and a storage unit 12. The control unit 11 is a processor such as a central processing unit (CPU). The control unit 11 has a data collection calculation unit 111, a control calculation unit 112, a setting receiving calculation unit 113, a data processing calculation unit 114, and a timing notification unit 115.

Note that the control unit 11 actually has one or more data collection calculation units 111, control calculation units 112, setting receiving calculation units 113, and data processing calculation units 114, but each of these components will be described as a single component in the present specification for the sake of convenience in description.

The storage unit 12 includes, for example, a random access memory (RAM), a hard disk drive, and a solid state drive (SSD), and stores various types of data. Moreover, the storage unit 12 has a primary data holding unit 121, a collection setting holding unit 122, and a data holding unit 123. Note that the storage unit 12 actually has one or more primary data holding units 121, collection setting holding units 122, and data holding units 123, but each of these components will be described as a single component in the present specification for the sake of convenience in description.

The data collection calculation unit 111 reads a setting channel from the collection setting holding unit 122, reads data corresponding to the data ID of the setting channel from the primary data holding unit 121, and writes the data read from the primary data holding unit 121 in an arbitrary channel in the data holding unit 123. Moreover, the data collection calculation unit 111 is capable of determining a missing piece of data stored in the data holding unit 123.

Further, when notified of processing timing from the timing notification unit 115, the data collection calculation unit 111 determines, after a lapse of arbitrary time, whether or not the setting receiving calculation unit 113 is executing request receiving processing.

The data collection calculation unit 111 executes data collection processing in a case where the request receiving processing is not in progress, and executes the data collection processing after having stood by until completion of the request receiving processing in a case where the request receiving processing is in progress. With this configuration, the control device 10 can execute the data collection processing at proper timing.

When notified of processing timing from the timing notification unit 115, the control calculation unit 112 performs, after a lapse of arbitrary time, processing of writing a current value of a preset control value in the primary data holding unit 121. Alternatively, the control calculation unit 112 performs processing of writing, from a channel set with a data ID in the collection setting holding unit 122, data corresponding to the data ID in the primary data holding unit 121, and writes an arbitrary value different from a previously-set value in an update sequence number in the primary data holding unit 121.

Moreover, when notified of the processing timing from the timing notification unit 115, the control calculation unit 112 executes the processing at the same time as that by the data collection calculation unit 111.

When notified of processing timing from the timing notification unit 115, the setting receiving calculation unit 113 executes, after a lapse of arbitrary time, the request receiving processing of receiving, from a user, a collection setting request including a data ID and a user ID via, e.g., a network.

In a case where the data ID is not registered for any channel in the collection setting holding unit 122, the setting receiving calculation unit 113 writes the data ID and the user ID in an unregistered channel for which any data ID is not registered in the collection setting holding unit 122, and records a reference to the primary data holding unit 121 in the unregistered channel.

In a case where the data ID is registered for any channel in the collection setting holding unit 122, the setting receiving calculation unit 113 adds the user ID to a setting channel list in such a channel.

The data processing calculation unit 114 reads data from the data holding unit 123, and transmits the read data via the network or performs analytical calculation for the read data.

The timing notification unit 115 increments, in every control period, a lap count value by a preset increment value, and notifies the processing timing of executing the processing to the data collection calculation unit 111, the control calculation unit 112, the setting receiving calculation unit 113, and the data processing calculation unit 114 in the control device 10.

The primary data holding unit 121 stores data, which corresponds to a single control period, held for control in the control device 10, such as a sensor value, a feedback value, or a command value calculated for control from the feedback value. The collection setting holding unit 122 stores, as a collection setting, a setting channel including a reference to the primary data holding unit 121, a data ID specifying collected data, and a request user list which is the list of users having requested a data ID.

The data holding unit 123 has collection channels for storing collected data, and in each collection channel, has a chunk list having a queue structure function of reading a chunk in the order of addition of chunks. Moreover, the data holding unit 123 holds an update sequence number. Note that in the present embodiment, the chunk indicates a data management unit in storage of results obtained by sampling of a single type of data for a certain period of time. The chunk has a data holding area with a queue structure function and a missing piece information holding area with a queue structure function.

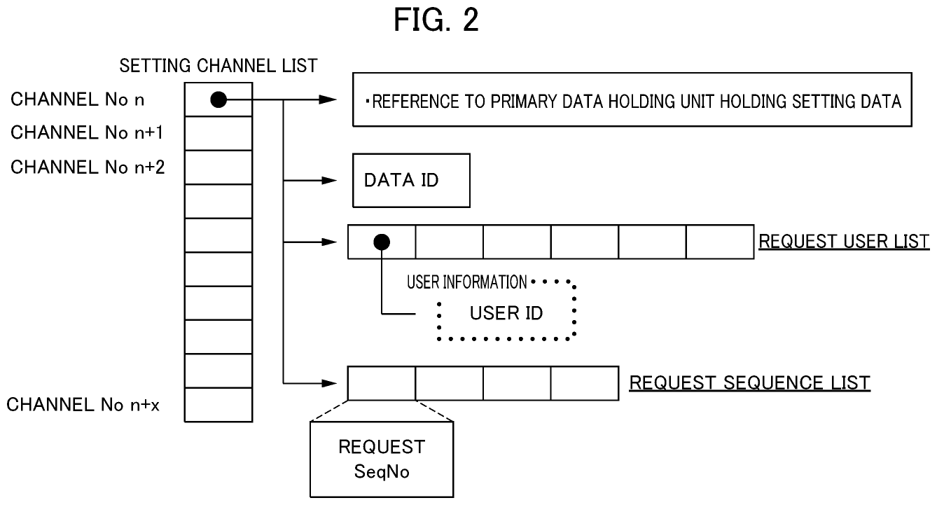

FIG. 2 is a diagram showing one example of the setting channel which is the collection setting stored in the collection setting holding unit 122. The collection setting holding unit 122 stores, as the collection settings, a setting channel list as shown in FIG. 2.

Each channel of the setting channel list has a reference to the primary data holding unit 121 holding data, a data ID specifying collected data, a request user list which is the list of users having requested the data ID, and a request sequence list of request sequence numbers.

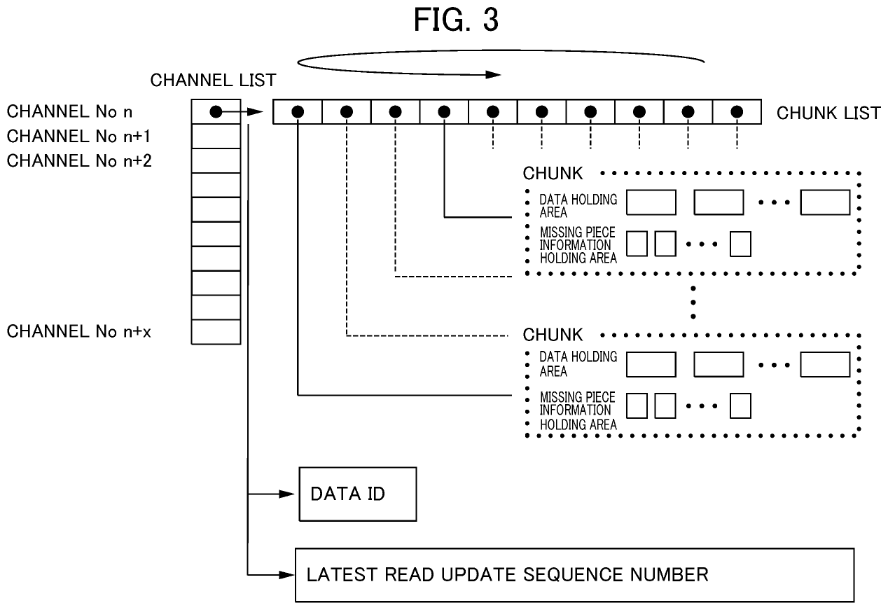

FIG. 3 is a diagram showing one example of a channel list stored in the data holding unit 123. The data holding unit 123 stores the channel list as shown in FIG. 3. Each channel of the channel list stores a chunk list, a data ID, and a latest read request sequence number. The chunk list has a queue structure function, and chunks, each of which has a data holding area and a missing piece information holding area, can be written in and read from in a first-in first-out (FIFO) order. Moreover, a chunk at an arbitrary location is referenceable.

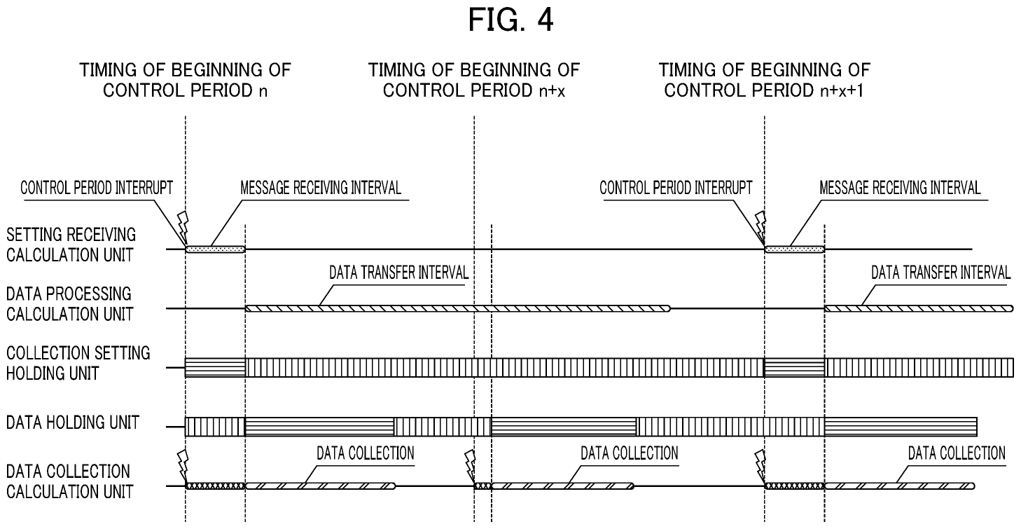

FIG. 4 is a timing chart regarding the processing by each component of the control device 10 according to the present embodiment. The timing chart shown in FIG. 4 shows the timing of each type of processing executed by the setting receiving calculation unit 113, the data processing calculation unit 114, the collection setting holding unit 122, the data holding unit 123, and the data collection calculation unit 111.

As shown in FIG. 4, when receiving a control period interrupt (timing of the beginning of a control period n), the setting receiving calculation unit 113 receives a collection setting request made by the user and writes a collection setting based on the collection setting request in the collection setting holding unit 122 in a message receiving interval.

When receiving a control period interrupt (timing of the beginning of the control period n), the data collection calculation unit 111 stands by until the end of the message receiving interval, and thereafter, reads a setting channel from the collection setting holding unit 122. The data collection calculation unit 111 reads data corresponding to the data ID of the setting channel from the primary data holding unit 121, and adds the data read from the primary data holding unit 121 to the end of the last chunk data of an arbitrary channel in the data holding unit 123. At this point, since both the channel list and the data holding area of each chunk have the queue structures, the data is easily added to the end (see DATA COLLECTION in FIG. 4).

That is, a period for writing data in the data holding unit 123 is coincident with a period for collecting data by the data collection calculation unit 111.

At the time of the start of data collection by the data collection calculation unit 111, the data processing calculation unit 114 starts transferring collected data, and not data being collected, via the network (DATA TRANSFER INTERVAL in FIG. 4).

Thereafter, when receiving a control period interrupt (timing of the beginning of a control period n+x), the data collection calculation unit 111 reads, after having stood by for a certain period of time, data corresponding to the data ID of the setting channel from the primary data holding unit 121, and adds the data read from the primary data holding unit 121 to the end of the last chunk data of the arbitrary channel in the data holding unit 123. At this point, since both the channel list and the data holding area of each chunk have the queue structures, the data is easily added to the end (see DATA COLLECTION in FIG. 4).

Thereafter, when receiving a control period interrupt (timing of the beginning of a control period n+x+1), the setting receiving calculation unit 113 receives a collection setting request made by the user and writes a collection setting based on the collection setting request in the collection setting holding unit 122 in a message receiving interval.

When receiving a control period interrupt (timing of the beginning of the control period n), the data collection calculation unit 111 stands by until the end of the message receiving interval, and thereafter, reads a setting channel from the collection setting holding unit 122. The data collection calculation unit 111 reads data corresponding to the data ID of the setting channel from the primary data holding unit 121, and adds the data read from the primary data holding unit 121 to the end of the last chunk data of an arbitrary channel in the data holding unit 123. At this point, since both the channel list and the data holding area of each chunk have the queue structures, the data is easily added to the end (see DATA COLLECTION in FIG. 4).

At the time of the start of data collection by the data collection calculation unit 111, the data processing calculation unit 114 starts transferring collected data, and not data being collected, via the network (DATA TRANSFER INTERVAL in FIG. 4)

Note that for the setting receiving calculation unit 113, a setting duplication interval may be provided after the message receiving interval. For example, in a case where the control device 10 includes two data processing calculation units 114, the setting receiving calculation unit 113 duplicates, in the setting duplication interval, a collection setting for each of the two data processing calculation units 114. With this configuration, even in a case where the control device 10 includes the two data processing calculation units 114, the collection setting for data collection can be properly made.

Further, the data collection calculation unit 111, the control calculation unit 112, the setting receiving calculation unit 113, the data processing calculation unit 114, and the timing notification unit 115 may perform the following processing.

In a case where the data ID of a collection setting request is registered for any channel in the collection setting holding unit 122, the setting receiving calculation unit 113 records user information in the request user list of such a channel.

In a case where the data ID of a deletion request for deleting data from the control device 10 has already been registered for any channel in the collection setting holding unit 122, the setting receiving calculation unit 113 deletes user information on a user having requested data deletion from the request user list of such a channel. Thereafter, the setting receiving calculation unit 113 deletes the data ID of this channel in a case where the request user list is empty.

The control device 10 may have one or more primary data holding units 121, collection setting holding units 122, and data holding units 123. With this configuration, the control device 10 can collect more data, or can respond to more users.

The data collection calculation unit 111 has a collection count value therein. Before execution of the data collection processing, the data collection calculation unit 111 increments the collection count value by a preset increment value.

The data collection calculation unit 111 reads a lap count value notified from the timing notification unit 115, and determines whether or not the collection count value and the lap count value are coincident with each other. In a case where the collection count value and the lap count value are not coincident with each other, the data collection calculation unit 111 adds data indicating a missing piece to the missing piece information holding area of the last chunk of an arbitrary channel in the data holding unit 123 by using the queue function of the missing piece information holding area, adds dummy data to the data holding area by using the queue function of the data holding area, and does not execute the data collection processing. Since the chunk list of the chunks has the queue structure and the missing piece information holding area also has the queue structure, the data can be easily added.

Here, the collection count value indicates the number of times of data collection by the data collection calculation unit 111 in response to timing notification from the timing notification unit 115. The lap count value indicates the value of increment by the timing notification unit 115 in every certain period (control period).

Inconsistency between the collection count value and the lap count value means that a single period of data collection processing by the data collection calculation unit 111 exceeds the control period. In this case, the control device 10 cannot collect data in every control period to maintain a time-series correlation although the control device 10 attempts to maintain such a correlation by data collection.

In this case, the missing piece information holding area of the chunk in the data holding unit 123 has the information indicating the “missing piece”, so that the control device 10 can record a weak time-series correlation of the data collected in such a control period.

A relationship between the collection count value and the lap count value is represented by Lap Count Value=N×(Collection Count Value). Note that N indicates a coefficient determined by how much each value is incremented for each control period.

On the other hand, in a case where the collection count value and the lap count value are coincident with each other, the data collection calculation unit 111 adds data indicating normal to the missing piece information holding area of the chunk in the data holding unit 123 by using the queue function of the missing piece information holding area, and executes the data collection processing. After execution of the data collection processing, the data collection calculation unit 111 reads the collection count value and the lap count value again, and determines (again) whether or not the collection count value and the lap count value are coincident with each other.

In a case where the collection count value and the lap count value are not coincident with each other, the data collection calculation unit 111 rewrites the last data of the missing piece information holding area of the last chunk of the arbitrary channel in the data holding unit 123 as a “missing piece”. Since the channel list of the chunks has the queue structure and the missing piece information holding area also has the queue structure, the data can be easily added.

For example, in a case where the time of the start of the data collection processing by the data collection calculation unit 111 is shifted and the end of the data collection processing is shifted to after the start of the subsequent control period, the data collection processing is not performed at timing at which data needs to be collected, and the collected data is not reliable. As described above, the collection count value and the lap count value are read again and it is determined whether or not the collection count value and the lap count value are coincident with each other, so that the control device 10 can properly determine whether the data is missing or normal.

When notified of the processing timing from the timing notification unit 115, the data processing calculation unit 114 sequentially reads, after a lapse of arbitrary time, data in the data holding area and data in the missing piece information holding area in the leading chunk of the chunk list of an arbitrary channel in the data holding unit 123 in the order from the leading chunk by using the queue function, and transmits the read data via the network, performs calculation as preprocessing for the read data, or performs analytical calculation for the read data. After reading of the data in the data holding area and the data in the missing piece information holding area in the chunk has been completed, the subsequent chunk is set as a leading chunk. The same processing is repeated an arbitrary number of times. At this point, since the chunk list, the data holding area, and the missing piece information holding area have the queue structures, the leading data can be easily read.

The collection setting holding unit 122 has a queue structure allowing first-in first-out of request sequence number data. Moreover, the collection setting holding unit 122 has a function of referring to a request sequence number at an arbitrary location. The request sequence number is an arbitrary value.

The primary data holding unit 121 holds data corresponding to a request from the user, or holds data, a request sequence number, and an update sequence number corresponding to a request from the user. The request sequence number and the update sequence number are arbitrary values.

Here, the request sequence number is a value for specifying data received by the control calculation unit 112 at the time of collection setting request.

One channel in the collection setting holding unit 122 has one reference to the primary data holding unit 121. However, in a case where the request sequence number in the primary data holding unit 121 and the request sequence number of one channel in the collection setting holding unit 122 are not coincident with each other, the control unit 11 does not store the data in a corresponding channel in the data holding unit 123.

The number of pieces of data holdable in the primary data holding unit 121 is limited. Thus, in a case where data is written in a channel n until a certain point of time and data is written in a channel m from a different point of time, the data collection calculation unit 111 determines whether to store the data in the channel n or the channel m with reference to the request sequence number.

Here, the update sequence number indicates a number for checking data update in every control period by the control calculation unit 112. The update sequence number is a value written after data update in every control period by the control calculation unit 112, and the control calculation unit 112 and the data collection calculation unit 111 operate at the same time. Thus, under normal conditions, after the control calculation unit 112 has ended data update in the primary data holding unit 121, the data collection calculation unit 111 attempts to read data from the primary data holding unit 121.

However, even in the same control period, the control calculation unit 112 sometimes delays data update due to control in progress. In this case, the control calculation unit 112 and the data collection calculation unit 111 are sure to set the update sequence number to a value different from that in the previous control period in order to notify the data collection calculation unit 111 of the data being not updated yet. Normally, the control calculation unit 112 and the data collection calculation unit 111 increment the update sequence number by one so that the update sequence number can be set to the value different from that in the previous control period.

In a case where the data collection calculation unit 111 reads the same update sequence number as the update sequence number read in the previous control period, the data collection calculation unit 111 writes data indicating a “missing piece” in the missing piece information holding area of a chunk in the data holding unit 123 in such a control period, or controls such that data collection is performed after the data collection calculation unit 111 has stood by for a certain period of time in the same control period.

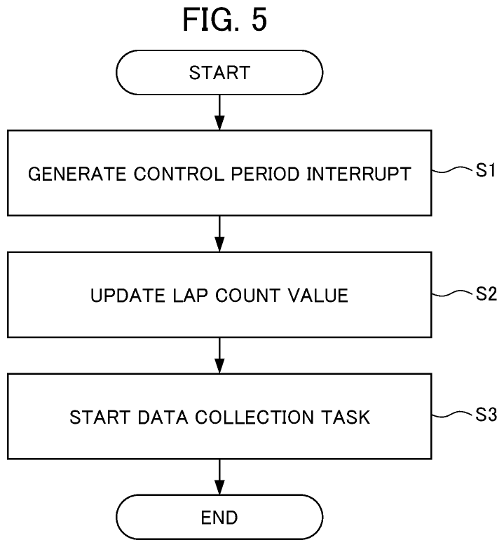

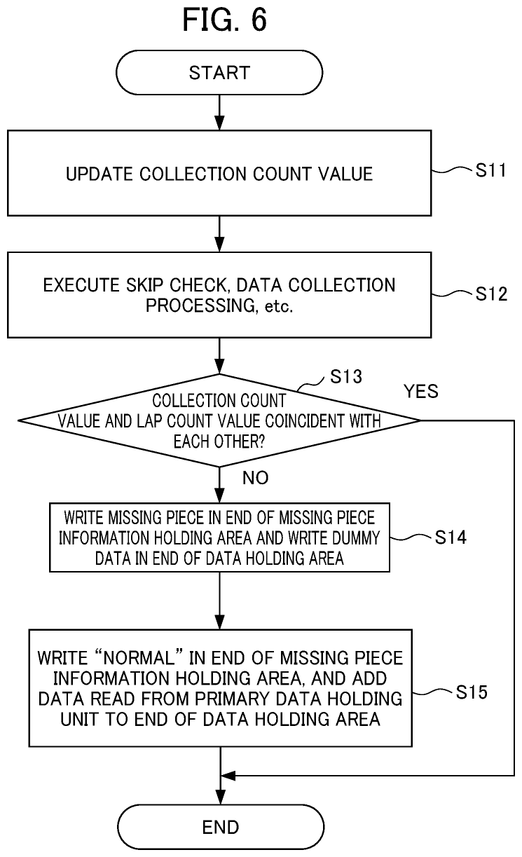

FIG. 5 is a flowchart showing the flow of processing in control period interrupt. FIG. 6 is a flowchart showing the flow of collection task processing. In Step S1 of FIG. 5, the timing notification unit 115 generates a control period interrupt in every certain control period, and notifies the processing timing to the data collection calculation unit 111, the control calculation unit 112, the setting receiving calculation unit 113, and the data processing calculation unit 114.

In Step S2, the timing notification unit 115 updates the lap count value. In Step S3, the data collection calculation unit 111 starts a data collection task. Note that in a case where the collection task has already been started and operation is in progress, the data collection calculation unit 111 does not start the data collection task.

In Step S11 of FIG. 6, the data collection calculation unit 111 updates the collection count value when starting the data collection task in Step S3 of FIG. 5. In Step S12, the data collection calculation unit 111 executes skip check, the data collection processing, etc.

In Step S13, the data collection calculation unit 111 reads the lap count value notified from the timing notification unit 115, and determines whether or not the collection count value and the lap count value are coincident with each other. In a case where the collection count value and the lap count value are coincident with each other in Step S13 (YES), the processing proceeds to Step S15. In a case where the collection count value and the lap count value are not coincident with each other in Step S13 (NO), the processing proceeds to Step S14.

In a case where the collection count value and the lap count value are not coincident with each other, the data collection calculation unit 111 writes data indicating a missing piece in the end of the missing piece information holding area and writes dummy data in the end of the data holding area in Step S14.

In a case where the collection count value and the lap count value are coincident with each other, the data collection calculation unit 111 writes data indicating “normal” in the end of the missing piece information holding area and adds data read from a temporary data holding unit to the end of the data holding area in Step S15.

When notified of the processing timing from the timing notification unit 115, the control calculation unit 112 performs, after a lapse of arbitrary time, the processing of writing the current value of the preset control value in the primary data holding unit 121.

Alternatively, after having stood by until completion of the request receiving processing by the setting receiving calculation unit 113, the control calculation unit 112 reads an effective data ID and an effective request sequence number written at the end of the request sequence list from a channel set with the data ID in the collection setting holding unit 122.

Then, the control calculation unit 112 performs the processing of writing data corresponding to the read request sequence number and data ID in the primary data holding unit 121. Further, the control calculation unit 112 writes an arbitrary value different from the previously-set value in the update sequence number in the primary data holding unit 121. In addition, in the above-described writing processing, the control calculation unit 112 writes the request sequence number, the data, and the update sequence number in this order.

When notified of the processing timing from the timing notification unit 115, the data collection calculation unit 111 performs the collection processing of collecting data after a lapse of arbitrary time.

In the collection processing, after having confirmed that the setting receiving calculation unit 113 is not executing the request receiving processing or after having stood by until completion of the request receiving processing by the setting receiving calculation unit 113, the data collection calculation unit 111 reads, as the data corresponding to the data ID of the channel in the collection setting holding unit 122, the request sequence number, the data, and the update sequence number in this order from the primary data holding unit 121.

Then, in a case where the request sequence number is not present in the request sequence list in the collection setting holding unit 122, the data collection calculation unit 111 ends the collection processing. In a case where the request sequence number is present in the request sequence list in the collection setting holding unit 122, the data collection calculation unit 111 deletes the request sequence number registered before such a request sequence number from the data holding unit 123.

The data collection calculation unit 111 reads the update sequence number from the primary data holding unit 121. In a case where the read update sequence number and the above-described update sequence number in the data holding unit are not coincident with each other, the data collection calculation unit 111 writes data indicating “normal” in the missing piece information holding area in the data holding unit 123 by using the queue function of the missing piece information holding area, and adds the update sequence number read from the primary data holding unit 121 to the arbitrary channel in the data holding unit 123 by using the queue function.

In a case where the data ID received in collection setting request has already been registered in the collection setting holding unit 122, the setting receiving calculation unit 113 writes a new request sequence number in the request sequence list in the collection setting holding unit 122.

The control device 10 executes the above-described processing so that missing of data stored in the data holding unit 123 can be checked. Thus, data recovery can be improved. Moreover, the data recovery in the control device 10 is improved so that a high-accuracy data set can be created.

As described above, the control device 10 is provided in the industrial machine 1 to collect data. The control device 10 includes the primary data holding unit 121 that stores data, which corresponds to a single control period, held in the control device 10, the collection setting holding unit 122 that stores the setting channel which is the collection setting including the reference to the primary data holding unit 121, the data ID specifying data collected from the control device 10, and the request user list which is the list of the users having requested the data ID, the data holding unit 123 that has the collection channels for storing collected data and has, in each collection channel, the queue structure of reading data in the order of addition of data, and the data collection calculation unit 111 that executes the data collection processing of reading the setting channel from the collection setting holding unit 122, reading the data corresponding to the data ID of the setting channel, and writing the data read from the primary data holding unit 121 in the arbitrary channel in the data holding unit 123.

With this configuration, since the setting channel has the reference to the primary data holding unit 121, the data ID, and the request user list which is the list of the users, the control device 10 can perform the collection processing of collecting data at once in a case where a plurality of users has requested the same data. Thus, a burden on the data collection processing in the control device 10 can be reduced in a case where the plurality of users has requested the same data. With this configuration, the control device 10 can execute a high-load control program, or can collect more data. Since the data collection calculation unit 111 can collect data in every control period, the control device 10 can create a high-accuracy data set from collected data.

The control device 10 further includes the control calculation unit 112 that after the processing of writing the current value of the preset control value in the primary data holding unit 121 or completion of the request receiving processing, performs the processing of writing the data corresponding to the data ID of the channel in the collection setting holding unit 122 in the primary data holding unit 121, and the control calculation unit 112 executes the processing at the same time as that by the data collection calculation unit 111. With this configuration, the data collection calculation unit 111 and the control calculation unit 112 can execute the processing at the same time, and therefore, the burden on the collection processing of collecting data in the control device 10 can be reduced.

The control device 10 further includes the setting receiving calculation unit 113 that when notified of the processing timing from the timing notification unit 115, executes the request receiving processing of receiving the collection setting request including the data ID and the user ID from the user after a lapse of the arbitrary time. With this configuration, the control device 10 can collect data based on the user's collection setting request.

The control device 10 further includes the data processing calculation unit 114 that reads data from the data holding unit 123 and transmits the read data via the network or performs analytical calculation for the read data. With this configuration, the control device 10 can transmit collected data via the network, perform the preprocessing for easily analyzing collected data, or perform analytical calculation for collected data, and therefore, machine learning can be effectively performed from collected data, for example.

The control device 10 further includes the timing notification unit 115 that in every control period, increments the lap count value by the preset increment value and notifies the processing timing of executing the processing to the data collection calculation unit 111, the control calculation unit 112, the setting receiving calculation unit 113, and the data processing calculation unit 114 in the control device 10. With this configuration, the control device 10 can execute the data collection processing based on the notified processing timing.

The control device 10 has the one or more primary data holding units 121, collection setting holding units 122, and data holding units 123. With this configuration, in the control device 10, the efficiency of the storage unit 12 including the primary data holding unit 121, the collection setting holding unit 122, and the data holding unit 123 can be improved.

The data collection calculation unit 111 is capable of determining, using the collection count value and the lap count value, missing of data stored in the data holding unit 123. With this configuration, the control device 10 can check missing of data stored in the data holding unit 123, and therefore, the data recovery can be improved. Moreover, the data recovery in the control device 10 is improved so that a high-accuracy data set can be created.

The embodiment of the present invention has been described above, and the control device 10 described above may be implemented by hardware, software, or a combination thereof. A control method performed by the control device 10 described above may also be implemented by hardware, software, or a combination thereof. Here, implementation by the software means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RAM)).

Each embodiment described above is a preferable embodiment of the present invention, but the scope of the present invention is not limited only to each embodiment above. Various changes can be made without departing from the gist of the present invention.

### EXPLANATION OF REFERENCE NUMERALS

1 Industrial Machine
10 Control Device
11 Control Unit
12 Storage Unit
111 Data Collection Calculation Unit
110 Control Calculation Unit
113 Setting Receiving Calculation Unit
114 Data Processing Calculation Unit
115 Timing Notification Unit
121 Primary Data Holding Unit
122 Collection Setting Holding Unit
123 Data Holding Unit

1. A control device provided in an industrial machine to collect data, comprising:
a primary data holding unit that stores data, which corresponds to a single control period, held in the control device;
a collection setting holding unit that stores a collection setting including a reference to the primary data holding unit, a data ID specifying data collected from the control device, and a request user list which is a list of users having requested the data ID;
a data holding unit that has a collection channel for storing data collected from the control device and has, in the collection channel, a queue structure for reading data in an order of addition of data; and
a data collection calculation unit that executes data collection processing including reading the collection setting from the collection setting holding unit, reading data corresponding to the data ID of the collection setting from the primary data holding unit, and writing the data read from the primary data holding unit in an arbitrary channel in the data holding unit.

2. The control device according to claim 1, further comprising a timing notification unit that increments a lap count value by a preset increment value and notifies processing timing of executing processing in the control device.

3. The control device according to claim 2, further comprising a setting receiving calculation unit that,
when notified of the processing timing from the timing notification unit, executes request receiving processing of receiving a collection setting request including a data ID and a user ID from a user after a lapse of arbitrary time,
in a case where the data ID is not registered for any channel in the collection setting holding unit, writes the data ID and the user ID in an unregistered channel for which any data ID is not registered in the collection setting holding unit and records a reference to the primary data holding unit in the unregistered channel, and
in a case where the data ID is registered for any channel in the collection setting holding unit, adds the user ID to a setting channel list in the any channel.

4. The control device according to claim 3, further comprising a data processing calculation unit that reads data from the data holding unit and transmits the read data via a network or performs analytical calculation for the read data.

5. The control device according to claim 3, wherein, when notified of the processing timing from the timing notification unit, the data collection calculation unit
determines, after a lapse of arbitrary time, whether or not the setting receiving calculation unit is executing the request receiving processing,
executes the data collection processing in a case where the request receiving processing is not in progress, and
executes the data collection processing after having stood by until completion of the request receiving processing in a case where the request receiving processing is in progress.

6. The control device according to claim 3, further comprising a control calculation unit that,
when notified of the processing timing from the timing notification unit, performs, after a lapse of arbitrary time, processing of writing a current value of a preset control value in the primary data holding unit, or
performs processing of writing, after completion of the request receiving processing, data corresponding to a data ID of a channel in the collection setting holding unit in the primary data holding unit,
wherein the control calculation unit executes processing at a same time as that by the data collection calculation unit.

7. The control device according to claim 3, wherein the setting receiving calculation unit
records, in a case where the data ID of the collection setting request is registered for any channel in the collection setting holding unit, user information in the request user list of the any channel,
in a case where the data ID of a deletion request for deleting data from the control device is registered for any channel in the collection setting holding unit, deletes the user information from the request user list of the any channel, and
in a case where the request user list is empty, deletes the data ID of the any channel.

8. The control device according to claim 1, wherein in the control device, the primary data holding unit, the collection setting holding unit, and the data holding unit include one or more primary data holding units, one or more collection setting holding units, and one or more data holding units.

9. The control device according to claim 5, wherein the data collection calculation unit
has a collection count value indicating the number of times of data collection from the control device,
increments, before execution of the data collection processing, the collection count value by a preset increment value,
reads the lap count value from the timing notification unit,
in a case where the collection count value and the lap count value are not coincident with each other, adds data indicating a missing piece to a missing piece information holding area of a chunk in the data holding unit by using a queue function of the missing piece information holding area, adds dummy data to a data holding area by using a queue function of the data holding area, and does not execute the data collection processing, and
in a case where the collection count value and the lap count value are coincident with each other, adds data indicating normal to the missing piece information holding area of the chunk in the data holding unit by using the queue function of the missing piece information holding area, and executes the data collection processing.

10. The control device according to claim 9, wherein the data collection calculation unit
reads, after execution of the data collection processing, the collection count value and the lap count value again, and
in a case where the collection count value and the lap count value are not coincident with each other, rewrites last data of the missing piece information holding area of the chunk in the data holding unit as a missing piece.

11. The control device according to claim 4, wherein when notified of the processing timing from the timing notification unit, the data processing calculation unit sequentially reads, after a lapse of arbitrary time, data in an order from a leading chunk in the data holding unit by using queue functions of data holding area and missing piece information holding area of a chunk in the data holding unit, and transmits the read data via the network or performs the analytical calculation for the read data.

12. The control device according to claim 6, wherein
the collection setting holding unit is configured to set a request sequence list having a queue structure allowing first-in first-out of data on a request sequence number which is an arbitrary value,
the primary data holding unit holds the request sequence number, and
when notified of the processing timing from the timing notification unit, the control calculation unit performs, after a lapse of arbitrary time, processing of writing a current value of a preset control value in the primary data holding unit, or performs processing of reading, from a channel set with a data ID in the collection setting holding unit, a request sequence number and a data ID written in an end of a request sequence list and writing data corresponding to the read request sequence number and data ID in the primary data holding unit.

13. The control device according to claim 12, wherein the data collection calculation unit
performs, when notified of the processing timing from the timing notification unit, collection processing of collecting data after a lapse of arbitrary time,
in the collection processing, after having confirmed that the setting receiving calculation unit is not executing the request receiving processing or after having stood by until completion of the request receiving processing by the setting receiving calculation unit, reads, as data corresponding to a data ID of a channel in the collection setting holding unit, a request sequence number, data, and an update sequence number in this order from the primary data holding unit,
in a case where the request sequence number is not present in a request sequence list in the collection setting holding unit, ends the collection processing, and
in a case where the request sequence number is present in the request sequence list in the collection setting holding unit, deletes a request sequence number registered before the request sequence number from the data holding unit.

14. The control device according to claim 12, wherein
the primary data holding unit holds an update sequence number and the update sequence number indicates a number for checking data update in every control period by the control calculation unit,
the data holding unit holds the update sequence number,
when notified of the processing timing from the timing notification unit, the control calculation unit performs, after a lapse of arbitrary time, processing of writing a current value of a preset control value in the primary data holding unit, or performs processing of writing, from a channel set with a data ID in the collection setting holding unit, data corresponding to the data ID in the primary data holding unit and writes an arbitrary value different from a previously-set value in the update sequence number in the primary data holding unit, and
the data collection calculation unit
performs, when notified of the processing timing from the timing notification unit, collection processing of collecting data after a lapse of arbitrary time,
in the collection processing, after having confirmed that the setting receiving calculation unit is not executing the request receiving processing or after having stood by until completion of the request receiving processing by the setting receiving calculation unit, reads, as data corresponding to a data ID of a channel in the collection setting holding unit, data and an update sequence number from the primary data holding unit, and in a case where the update sequence number read from the primary data holding unit and the update sequence number in the data holding unit are coincident with each other, writes data indicating a missing piece in a missing piece information holding area of a chunk in the data holding unit by using a queue function of the missing piece information holding area,
in a case where the update sequence number read from the primary data holding unit and the update sequence number in the data holding unit are not coincident with each other, writes data indicating normal in the missing piece information holding area in the data holding unit by using the queue function of the missing piece information holding area, and
adds the update sequence number read from the primary data holding unit to an arbitrary channel in the data holding unit by using a queue function.
